(19) United States
(12) Patent Application Publication
(10) Pub. No.: US 2011/0244293 A1
(43) Pub. Date: Oct. 6, 2011

(54) SECONDARY BATTERY MODULE

(75) Inventors: Bahram Khalighi, Troy, MI (US); Kuo-Huey Chen, Troy, MI (US); Taeyoung Han, Bloomfield Hills, MI (US)

(73) Assignee: GM GLOBAL TECHNOLOGY OPERATIONS, INC., Detroit, MI (US)

(21) Appl. No.: 12/754,117

(22) Filed: Apr. 5, 2010

(51) Int. Cl. H01M 10/50

(52) U.S. Cl. 429/120

(57) ABSTRACT

A secondary battery module includes a plurality of secondary battery cells each having a measureable temperature and each spaced apart from an adjacent one of the secondary battery cells to define a cooling channel therebetween. The plurality of cells includes a first one of the cells having a measureable first temperature and a terminal one of the cells having a measureable terminal temperature and separated from the first one of the cells by at least one other of the cells. The module includes a fluid flowable within each of the cooling channels and in thermal energy exchange relationship with each of the cells, and a housing defining an inlet channel disposed in fluid flow communication with each of the cooling channels and configured for directing fluid flow uniformly to each of the cooling channels, and further defining a plurality of inlet ports in fluid flow communication with the inlet channel.

### TECHNICAL FIELD

The present invention generally relates to secondary battery modules, and more specifically, to secondary battery modules including an inlet channel and a plurality of inlet ports.

### BACKGROUND OF THE INVENTION

Batteries are useful for converting chemical energy into electrical energy, and may be described as primary or secondary. Primary batteries are generally non-rechargeable, whereas secondary batteries are readily rechargeable and may be restored to a full charge after use. As such, secondary batteries may be useful for applications such as powering electronic devices, tools, machinery, and vehicles. For example, secondary batteries for vehicle applications may be recharged external to the vehicle via a plug-in electrical outlet, or onboard the vehicle via a regenerative event.

A secondary battery, which may also be known as a secondary battery pack, may include one or more secondary battery modules. Similarly, a secondary battery module may include one or more secondary battery cells positioned adjacent to each other, e.g., stacked. When such secondary batteries are charged or discharged, heat is produced within the secondary battery module. If uncontrolled, such heat can detrimentally impact the life and performance of the secondary battery module and individual secondary battery cells. In particular, heat may contribute to secondary battery cell mismatch, i.e., a reduced state of health for one secondary battery cell as compared to other secondary battery cells.

### SUMMARY OF THE INVENTION

A secondary battery module includes a plurality of secondary battery cells each having a measureable temperature and each spaced apart from an adjacent one of the secondary battery cells to define a cooling channel therebetween. Further, the plurality of secondary battery cells includes a first one of the secondary battery cells having a measureable first temperature and a terminal one of the secondary battery cells having a measureable terminal temperature and separated from the first one of the secondary battery cells by at least one other of the secondary battery cells. The secondary battery module also includes a fluid flowable within each of the cooling channels and in thermal energy exchange relationship with each of the secondary battery cells. Additionally, the secondary battery module includes a housing defining an inlet channel disposed in fluid flow communication with each of the cooling channels and configured for directing the fluid flow uniformly to each of the cooling channels. The housing further defines a plurality of inlet ports in fluid flow communication with the inlet channel.

In another variation, the housing also defines an outlet channel disposed in fluid flow communication with each of the cooling channels and configured for directing the fluid flow away from each of the cooling channels. The housing further defines a plurality of outlet ports in fluid flow communication with the outlet channel and each configured for exhausting the fluid flow from the secondary battery module.

In yet another variation, the housing defines exactly two inlet ports in fluid flow communication with the inlet channel and exactly two outlet ports in fluid flow communication with the outlet channel.

The secondary battery modules provide excellent temperature control for secondary batteries. That is, fluid flow across the cooling channels is substantially uniform, and therefore the secondary battery modules have substantially uniform temperature distributions across a length of the secondary battery modules during operation. In particular, during operation, the plurality of inlet ports and/or outlet ports minimizes non-uniform cooling of the secondary battery module by providing substantially uniform flow distribution across the cooling channels. Further, the substantially uniform temperature distribution minimizes cell mismatch between individual secondary battery cells of the secondary battery module during operation. Additionally, the secondary battery modules provide excellent cooling without the use of flow control baffles and/or guiding vanes, and are therefore economical to produce. Finally, since the secondary battery modules allow for air cooling, the secondary battery modules are versatile and useful for applications requiring minimized mass and weight. The secondary battery modules have excellent performance and longevity.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is an exploded schematic perspective view of a secondary battery and components thereof, including a plurality of secondary battery cells and a plurality of secondary battery modules; and

FIG. 2 is a schematic perspective view of the secondary battery module of FIG. 1.

### DESCRIPTION OF THE PREFERRED EMBODIMENTS

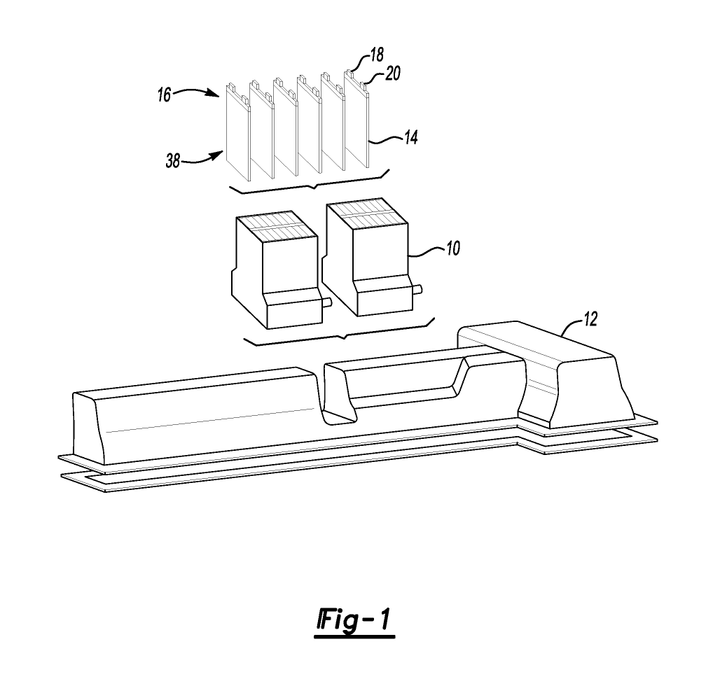

Referring to the Figures, wherein like reference numerals refer to like elements, a secondary battery module is shown generally at 10 in FIG. 1. The secondary battery module 10 may be useful for a variety of applications requiring rechargeable battery power, such as, but not limited to, electronic devices, tools, machinery, and vehicles. For example, the secondary battery module 10 may be useful for electric and hybrid electric vehicles. However, it is to be appreciated that the secondary battery module 10 may also be useful for non-automotive applications, such as, but not limited to, household and industrial power tools and electronic devices.

Referring to FIG. 1, a secondary battery module 10 for an automotive application may be useful for automotive applications, such as for a plug-in hybrid electric vehicle (PHEV). For example, the secondary battery module 10 may be a lithium ion secondary battery module 10. Referring again to FIG. 1, a plurality of battery modules 10 may be combined to form a secondary battery 12, i.e., a secondary battery pack. By way of example, the secondary battery module 10 may be sufficiently sized to provide a necessary voltage for powering a hybrid electric vehicle (HEV), an electric vehicle (EV), a plug-in hybrid electric vehicle (PHEV), and the like, e.g., approximately 300 to 400 volts or more, depending on the required application.

Referring again to FIG. 1, the secondary battery module 10 includes a plurality of secondary battery cells 14 positioned adjacent one another. The secondary battery cells 14 may be any suitable electrochemical battery cell. For example, the secondary battery cells 14 may be lithium ion, lithium ion polymer, lithium iron phosphate, lithium vanadium pentoxide, lithium copper chloride, lithium manganese dioxide, lithium sulfur, lithium titanate, nickel metal hydride, nickel cadmium, nickel hydrogen, nickel iron, sodium sulfur, vanadium redox, lead acid, and combinations thereof.

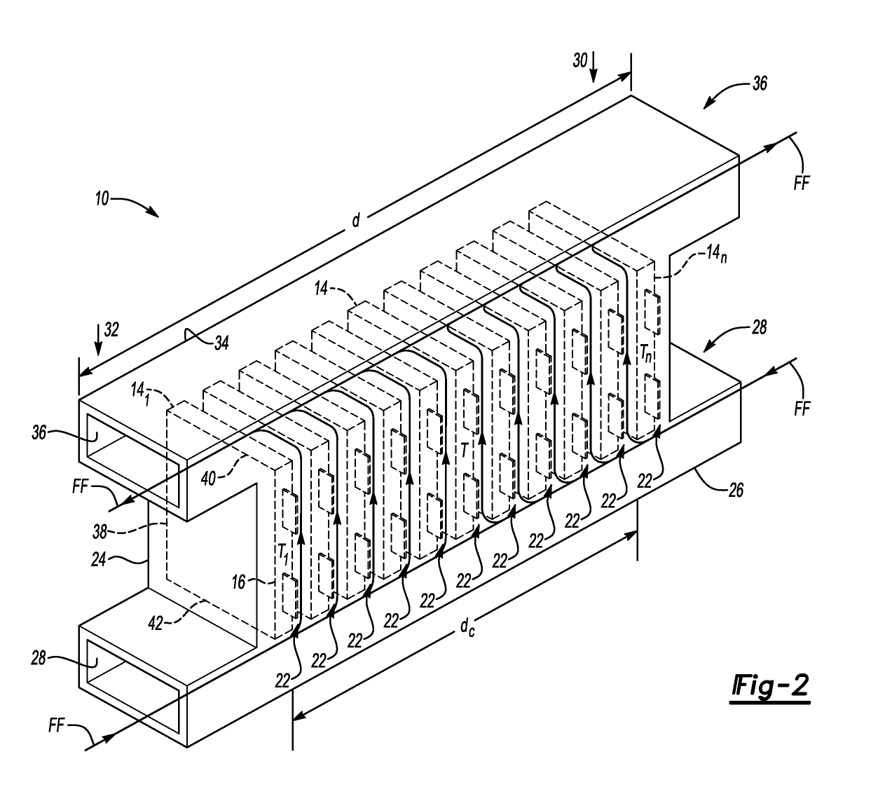

Referring now to FIGS. 1 and 2, each secondary battery cell 14 may have a first end 16 including positive cell tab 18 and a negative cell tab 20, and a second end 38 spaced apart from the first end 16. The secondary battery cell 14 may be suitable for stacking. That is, the secondary battery cell 14 may be formed from a heat-sealable, flexible foil that is sealed to enclose a cathode, an anode, and a separator (not shown). Therefore, any number of secondary battery cells 14 may be stacked or otherwise placed adjacent to each other to form a cell stack, i.e., the secondary battery module 10. Further, although not shown, additional layers, such as, but not limited to, frames and/or cooling layers may also be positioned in the space between individual secondary battery cells 14. The actual number of secondary battery cells 14 may be expected to vary with the required voltage output of each secondary battery module 10. Likewise, the number of interconnected secondary battery modules 10 may vary to produce the necessary total output voltage for a specific application.

During operation, a chemical redox reaction may transfer electrons from a region of relatively negative potential to a region of relatively positive potential to thereby cycle, i.e., charge and discharge, the secondary battery cells 14 and the secondary battery module 10 to provide voltage to power applications requiring the secondary battery 12.

Referring to FIG. 2, during operation, each secondary battery cell 14 has a measureable temperature, T. More specifically, the plurality of secondary battery cells 14 includes a first one of the secondary battery cells 14₁ having a measureable first temperature, T₁, and a terminal one of the secondary battery cells 14ₙ having a measureable terminal temperature, Tₙ during operation. The terminal one of the secondary battery cells 14ₙ is separated from the first one of the secondary battery cells 14₁ by at least one other of the secondary battery cells 14₂. That is, the secondary battery module 10 includes at least three secondary battery cells 14. However, the secondary battery module 10 may include any suitable number of secondary battery cells 14, e.g., from about 3 to about 100 secondary battery cells 14.

Further, the secondary battery cells 14 may be connected in series to provide the desired voltage of the secondary battery module 10 and/or secondary battery 12 (FIG. 1). A distance, d_{c}, between the first one of the secondary battery cells 14₁ and the terminal one of the secondary battery cells 14ₙ may be from about 0.5 m to about 2 m.

Additionally, referring again to FIG. 2, each secondary battery cell 14 is spaced apart from an adjacent one of the secondary battery cells 14 to define a cooling channel 22 therebetween. That is, one cooling channel 22 may be sandwiched between two adjacent secondary battery cells 14₁, 14₂. Further, each of the cooling channels 22 may have a width, w, of from about 0.5 mm to about 1.5 mm.

Referring to FIG. 2, the secondary battery module 10 also includes a fluid (designated by fluid flow arrows FF in FIG. 2) flowable within each of the cooling channels 22. For example, the fluid flow (arrows FF) may be contained by the cooling channels 22 and have a sufficient viscosity for flowing through the cooling channel 22. The fluid flow (arrows FF) is in thermal energy exchange relationship with each of the secondary battery cells 14. Stated differently, during operation, the fluid flow (arrows FF) is capable of changing the measureable temperature, T, of each of the secondary battery cells 14. That is, the fluid flow (arrows FF) may have a temperature that is lower than the measureable temperature, T, of the respective secondary battery cells 14 so as to cool the secondary battery cells 14, as set forth in more detail below. The fluid flow (arrows FF) may be a gas, such as air, a liquid, such as a hydrocarbon refrigerant, or combinations thereof, such as a carbonated liquid. Air is a suitable fluid (arrows FF) of the secondary battery module 10.

Referring again to FIG. 2, the secondary battery module 10 also includes a housing 24 defining an inlet channel 26 disposed in fluid flow communication with each of the cooling channels 22 and configured for directing the fluid flow (arrows FF) uniformly to each of the cooling channels 22. That is, the inlet channel 26 may convey the fluid flow (arrows FF) from a fluid source, e.g., ambient air surrounding the secondary battery module 10, to each of the cooling channels 22. As such, the inlet channel 26 may function as an inlet manifold.

Referring to FIG. 2, the housing 24 further defines a plurality of inlet ports 28 in fluid flow communication with the inlet channel 26. Each inlet port 28 may be configured for intaking the fluid flow (arrows FF) to the secondary battery module 10. The housing 24 may define any suitable number of inlet ports 28. For example, the housing 24 may define exactly two inlet ports 28 each spaced opposite and apart from the other. That is, one inlet port 28 may be disposed at a distal end 30 of the secondary battery module 10, and the other inlet port 28 may be disposed at a proximal end 32 of the secondary battery module 10. In this configuration, a distance, d, between the two inlet ports 28 may be from about 0.5 m to about 2 m. Alternatively, although not shown, the inlet ports 28 may be disposed on parallel but opposite faces of the inlet channel 26. The plurality of inlet ports 28 may be similarly shaped and/or sized. Alternatively, one inlet port 28 may be shaped and/or sized differently from another inlet port 28. In operation, the plurality of inlet ports 28 may receive the fluid flow (arrows FF) from, for example, the source (not shown) so that the inlet channel 26 may direct the fluid flow (arrows FF) to each of the cooling channels 22.

Referring again to FIG. 2, in another variation, the housing 24 further defines an outlet channel 34 disposed in fluid flow communication with each of the cooling channels 22 and configured for directing the fluid flow (arrows FF) away from each of the cooling channels 22. That is, the outlet channel 34 may function as an outlet manifold. The outlet channel 34 may convey the fluid flow (arrows FF) from each of the cooling channels 22 to exhaust the fluid flow (arrows FF) from, and/or recirculate the fluid flow (arrows FF) throughout, the secondary battery module 10. Further, the outlet channel 34 may be spaced opposite and apart from the inlet channel 26.

Referring to FIG. 2, in this variation, the housing 24 further defines a plurality of outlet ports 36 in fluid flow communication with the outlet channel 34 and each configured for exhausting the fluid flow (arrows FF) from the secondary battery module 10. The housing 24 may define any suitable number of outlet ports 36. For example, the housing 24 may define exactly two outlet ports 36 each spaced opposite and apart from the other. That is, one outlet port 36 may be disposed at the distal end 30 of the secondary battery module 10, and the other outlet port 36 may be disposed at a proximal end 32 of the secondary battery module 10. Alternatively, although not shown, the outlet ports 36 may be disposed on parallel but opposite faces of the outlet channel 34. The plurality of outlet ports 36 may be similarly shaped and/or sized. Alternatively, one outlet port 36 may be shaped and/or sized differently from another outlet port 36. In operation, the plurality of outlet ports 36 may remove the fluid flow (arrows FF) from the secondary battery module 10.

As shown in FIG. 2, each of the secondary battery cells 14 may be disposed between the inlet channel 26 and the outlet channel 34. For example, in contrast to the inlet channel 26 that may be disposed at a first side 40 of each of the secondary battery cells 14, the outlet channel 34 may be disposed at a second side 42 spaced opposite from the first side 40 of each of the secondary battery cells 14. Therefore, the plurality of secondary battery cells 14 may be disposed between the inlet channel 26 and the outlet channel 34 so that the cooling channels 22 are in fluid flow communication with both the inlet and outlet channels 26, 34.

Therefore, in operation and described with reference to FIG. 2, the plurality of inlet ports 28 intake the fluid flow (arrows FF) into the inlet channel 26, and the inlet channel 26 directs the fluid flow (arrows FF) to each of the cooling channels 22 disposed between individual secondary battery cells 14. The fluid flow (arrows FF) may be passively or actively circulated into the inlet channel 26 through the inlet ports 28. For example, the fluid flow (arrows FF) may drift into the inlet channel 26 or may be blown into the inlet channel 26 by a fan.

The plurality of inlet ports 28 in fluid flow communication with the inlet channel 26 ensure that the fluid flow (arrows FF) is distributed to each of the cooling channels 22 so that a flow rate of the fluid (arrows FF) across the first one of the secondary battery cells 14₁ is substantially equal to a flow rate of the fluid (arrows FF) across the terminal one of the secondary battery cells 14ₙ during operation of the secondary battery module 10. That is, during operation, the plurality of inlet ports 28 provide multiple entry points of the fluid flow (arrows FF) to the secondary battery module 10 so that the flow rate of the fluid (arrows FF) does not substantially diminish along a length of the secondary battery module 10 between the first one of the secondary battery cells 14₁ and the terminal one of the secondary battery cells 14ₙ. In addition to the controlled flow path, the plurality of inlet ports 28 also provide a substantially uniform fluid flow distribution across the secondary battery module 10 so that each cooling channel 22 experiences a substantially equal fluid flow rate during operation.

Stated differently, each of the cooling channels 22 has a skin friction coefficient, C_{f}, of less than or equal to about 0.15. And, since the flow rate of the fluid (arrows FF) across the first one of the secondary battery cells 14₁ is substantially equal to the flow rate across the terminal one of the secondary battery cells 14ₙ during operation of the secondary battery module 10 each of the cooling channels 22 has a substantially equal skin friction coefficient, C_{f}. As used herein, the terminology “skin friction coefficient” is defined as a shearing stress exerted by the fluid flow (arrows FF) on a surface of the cooling channel 22 over which the fluid (arrows FF) flows. That is, the skin friction coefficient, C_{f}, refers to a dimensionless value of a measurement of the friction of the fluid flow (arrows FF) against a “skin” of the cooling channel 22, i.e., a fluid/cooling channel interface. Skin friction arises from an interaction between the fluid flow (arrows FF) and the skin of the cooling channel 22 and is related to an area of the cooling channel 22 that is in contact with the fluid flow (arrows FF).

Therefore, in operation, and with continued reference to FIG. 2, as the fluid (arrows FF) flows through each cooling channel 22, the fluid flow (arrows FF) is in thermal energy exchange relationship with each secondary battery cell 14 of the secondary battery module 10. That is, thermal energy, i.e., heat, generated during the charge and/or discharge of each secondary battery cell 14 may be transferred to the fluid flow (arrows FF) to thereby dissipate thermal energy from each secondary battery cell 14. Consequently, during operation, as the fluid flow (arrows FF) enters the plurality of inlet ports 28 and flows through the inlet channel 26, the fluid flow (arrows FF) is directed through each cooling channel 22 at a substantially equal flow rate so that the fluid flow (arrows FF) may dissipate thermal energy from each secondary battery cell 14 and thereby cool each secondary battery cell 14.

Likewise, the plurality of outlet ports 36 exhaust the fluid flow (arrows FF) from the outlet channel 34 and removes the fluid flow (arrows FF) from the secondary battery module 10. Since the fluid flow (arrows FF) including the accompanying thermal energy from the secondary battery cells 14 is exhausted through the plurality of outlet ports 36, each secondary battery cell 14 is efficiently cooled.

The measureable terminal temperature, Tₙ, of the terminal one of the secondary battery cells 14ₙ may be different than the measureable first temperature, T₁, of the first one of the secondary battery cells 14₁. However, a difference, ΔT₁₋ₙ, between the measureable first temperature, T₁, of the first one of the secondary battery cells 14₁ and the measureable terminal temperature, Tₙ, of the terminal one of the secondary battery cells 14ₙ may be less than or equal to about 5° C. during operation of the secondary battery module 10. Stated differently, the secondary battery module 10 has a substantially uniform measureable temperature, T, between secondary battery cells 14 during operation. Moreover, the measureable temperature, T, of each of the secondary battery cells 14 may be from about 25° C. to about 40° C., e.g., from about 25° C. to about 35° C. during operation of the secondary battery module 10. That is, the measureable temperature, T, across the secondary battery cells 14 may not vary by more than about 2° C. so that the secondary battery 12 (FIG. 1) including multiple secondary battery cells 14 may operate within the temperature range of from about 25° C. to about 40° C. Therefore, the plurality of inlet ports 28 in fluid flow communication with the inlet channel 26 and the plurality of outlet ports 36 in fluid flow communication with the outlet channel 34 each provides excellent cooling and substantially uniform temperature distribution across the secondary battery cells 14 and thereby minimizes uneven temperature distribution.

The secondary battery modules 10 provide excellent temperature control for secondary batteries 12. That is, fluid flow (arrows FF) across the cooling channels 22 is substantially uniform, and therefore the secondary battery modules 10 have substantially uniform temperature distributions across a length of the secondary battery modules 10 during operation. In particular, during operation, the plurality of inlet ports 28 and/or outlet ports 36 minimizes non-uniform cooling of the secondary battery module 10 by providing substantially uniform flow distribution across the cooling channels 22. Further, the substantially uniform temperature distribution minimizes cell mismatch between individual secondary battery cells 14 of the secondary battery module 10 during operation. Since each secondary battery cell 14 may be connected to other secondary battery cells 14 in series, performance of the secondary battery module 10 is maximized since no one secondary battery cell 14₁ is weaker than any other secondary battery cell 14ₙ when power is withdrawn from the secondary battery module 10. Therefore, the secondary battery modules 10 have excellent performance and longevity. Additionally, the secondary battery modules 10 provide excellent cooling without the use of flow control baffles and/or guiding vanes, and are therefore economical to produce. Finally, since the secondary battery modules 10 allow for air cooling, the secondary battery modules 10 are versatile and useful for applications requiring minimized mass and weight.

While the best modes for carrying out the invention have been described in detail, those familiar with the art to which this invention relates will recognize various alternative designs and embodiments for practicing the invention within the scope of the appended claims.

1. A secondary battery module comprising:
a plurality of secondary battery cells each having a measureable temperature and each spaced apart from an adjacent one of said secondary battery cells to define a cooling channel therebetween, wherein said plurality of secondary battery cells includes a first one of said secondary battery cells having a measureable first temperature and a terminal one of said secondary battery cells having a measureable terminal temperature and separated from said first one of said secondary battery cells by at least one other of said secondary battery cells;
a fluid flowable within each of said cooling channels and in thermal energy exchange relationship with each of said secondary battery cells; and
a housing defining an inlet channel disposed in fluid flow communication with each of said cooling channels and configured for directing said fluid flow uniformly to each of said cooling channels, wherein said housing further defines a plurality of inlet ports in fluid flow communication with said inlet channel.

2. The secondary battery module of claim 1, wherein said measureable terminal temperature is different than said measureable first temperature and the difference between said measureable first temperature and said measureable terminal temperature is less than or equal to about 5° C. during operation of the secondary battery module.

3. The secondary battery module of claim 1, wherein a flow rate of said fluid across said first one of said secondary battery cells is substantially equal to a flow rate of said fluid across said terminal one of said secondary battery cells during operation of the secondary battery module.

4. The secondary battery module of claim 1, wherein said housing defines exactly two inlet ports each spaced opposite and apart from the other.

5. The secondary battery module of claim 1, wherein said measureable temperature of each of said secondary battery cells is from about 25° C. to about 40° C. during operation of the secondary battery module.

6. A secondary battery module comprising;
a plurality of secondary battery cells each having a measureable temperature and each spaced apart from an adjacent one of said secondary battery cells to define a cooling channel therebetween, wherein said plurality of secondary battery cells includes a first one of said secondary battery cells having a measureable first temperature and a terminal one of said secondary battery cells having a measureable terminal temperature and separated from said first one of said secondary battery cells by at least one other of said secondary battery cells;
a fluid flowable within each of said cooling channels and in thermal energy exchange relationship with each of said secondary battery cells; and
a housing defining;
an inlet channel disposed in fluid flow communication with each of said cooling channels and configured for directing said fluid flow uniformly to each of said cooling channels, wherein said housing further defines a plurality of inlet ports in fluid flow communication with said inlet channel; and
an outlet channel disposed in fluid flow communication with each of said cooling channels and configured for directing said fluid flow away from each of said cooling channels, wherein said housing further defines a plurality of outlet ports in fluid flow communication with said outlet channel and each configured for exhausting said fluid flow from the secondary battery module.

7. The secondary battery module of claim 6, wherein said measureable terminal temperature is different than said measureable first temperature and the difference between said measureable first temperature and said measureable terminal temperature is less than or equal to about 5° C. during operation of the secondary battery module.

8. The secondary battery module of claim 6, wherein a flow rate of said fluid across said first one of said secondary battery cells is substantially equal to a flow rate of said fluid across said terminal one of said secondary battery cells during operation of the secondary battery module.

9. The secondary battery module of claim 6, wherein said inlet channel is spaced opposite and apart from said outlet channel.

10. The secondary battery module of claim 9, wherein each of said plurality of secondary battery cells is disposed between said inlet channel and said outlet channel.

11. The secondary battery module of claim 6, wherein said measureable temperature of each of said secondary battery cells is from about 25° C. to about 40° C. during operation of the secondary battery module.

12. A secondary battery module comprising;
a plurality of secondary battery cells each having a measureable temperature and each spaced apart from an adjacent one of said secondary battery cells to define a cooling channel therebetween, wherein said plurality of secondary battery cells includes a first one of said secondary battery cells having a measureable first temperature and a terminal one of said secondary battery cells having a measureable terminal temperature and separated from said first one of said secondary battery cells by at least one other of said secondary battery cells;
a fluid flowable within each of said cooling channels and in thermal energy exchange relationship with each of said secondary battery cells; and
a housing defining;
an inlet channel disposed in fluid flow communication with each of said cooling channels and configured for directing said fluid flow uniformly to each of said cooling channels, wherein said housing further defines exactly two inlet ports in fluid flow communication with said inlet channel; and
an outlet channel disposed in fluid flow communication with each of said cooling channels and configured for directing said fluid flow away from each of said cooling channels, wherein said housing further defines exactly two outlet ports in fluid flow communication with said outlet channel and each configured for exhausting said fluid flow from the secondary battery module.

13. The secondary battery module of claim 12, wherein said measureable terminal temperature is different than said measureable first temperature and the difference between said measureable first temperature and said measureable terminal temperature is less than or equal to about 5° C. during operation of the secondary battery module.

14. The secondary battery module of claim 12, wherein a flow rate of said fluid across said first one of said secondary battery cells is substantially equal to a flow rate of said fluid across said terminal one of said secondary battery cells during operation of the secondary battery module.

15. The secondary battery module of claim 12, wherein said inlet channel is spaced opposite and apart from said outlet channel.

16. The secondary battery module of claim 15, wherein each of said plurality of secondary battery cells is disposed between said inlet channel and said outlet channel.

17. The secondary battery module of claim 12, wherein each of said exactly two outlet ports is spaced opposite and apart from the other.

18. The secondary battery module of claim 17, wherein each of said exactly two inlet ports is spaced opposite and apart from the other.

19. The secondary battery module of claim 12, wherein said measureable temperature of each of said secondary battery cells is from about 25° C. to about 40° C. during operation of the secondary battery module.

20. The secondary battery module of claim 13, wherein a distance between said exactly two inlet ports is from about 0.5 m to about 2 m.
